(19) United States
(12) Patent Application Publication
(10) Pub. No.: US 2014/0212693 A1
(43) Pub. Date: Jul. 31, 2014

(54) MAGNETIC RECORDING MEDIUM

(71) Applicant: FUJIFILM Corporation, Tokyo (JP)

(72) Inventor: Yasushi HATTORI, Minami-ashigara-shi (JP)

(73) Assignee: FUJIFILM Corporation, Tokyo (JP)

(21) Appl. No.: 14/168,740

(22) Filed: Jan. 30, 2014

(30) Foreign Application Priority Data
Jan. 31, 2013 (JP) 2013-017279

(51) Int. Cl. G11B 5/706; G11B 5/702

(52) U.S. Cl. CPC G11B 5/70615; G11B 5/702
USPC 428/832

(57) ABSTRACT

The magnetic recording medium includes a magnetic layer containing a ferromagnetic powder and a binder on a nonmagnetic support, wherein the ferromagnetic powder is an ε-iron oxide powder, and the magnetic layer comprises a compound comprising at least one substituent selected from the group consisting of a hydroxyl group and a quaternary ammonium salt group.

### CROSS-REFERENCE TO RELATED APPLICATIONS

This application claims the benefit of priority under 35 USC 119 to Japanese Patent Application No. 2013-017279 filed on Jan. 31, 2013, which is expressly incorporated herein by reference in its entirety.

### BACKGROUND OF THE INVENTION

1. Field of the Invention

The present invention relates to a magnetic recording medium, and more particularly, to a magnetic recording medium having a magnetic layer in which an ε-iron oxide powder, a ferromagnetic powder suited to high density recording, is highly dispersed.

2. Discussion of the Background

With the increase in the amount of information being recorded, ever higher recording densities are being demanded of magnetic recording media. Accordingly, to achieve high-density recording, microparticulate magnetic material is widely employed to increase the fill rate of the magnetic layer.

Conventionally, primarily ferromagnetic metal powder has come to be used in the magnetic layer of magnetic recording media for high-density recording. However, limits to improvement in ferromagnetic metal powder for achieving higher density recording have started to appear. That is because when the size of the particles is reduced in a ferromagnetic metal powder, superparamagnetism ends up occurring due to thermal fluctuation, precluding use in magnetic recording media.

The ε-iron oxide powder that has conventionally been used mainly in permanent magnets has high crystal magnetic anisotropy derived from its crystalline structure and can afford good thermal stability. Even when rendered as a fine powder, it can maintain good magnetic characteristics suited to magnetic recording. For that reason, the use of ε-iron oxide powder in magnetic recording has been proposed in recent years (for example, see Japanese. Unexamined Patent Publication (KOKAI) No. 2008-60293 and its English language family members US2008/057352A1 and U.S. Pat. No. 7,781,082, which are expressly incorporated herein by reference in their entirety).

One characteristic that is required of magnetic recording media for high-density recording is that they have a magnetic layer with a high degree of surface smoothness. To that end, it is important that the ferromagnetic powder be dispersed to a high degree. However, in permanent magnets, which have been the main conventional application of ε-iron oxide, there is no requirement that the ε-iron oxide by dispersed to a high degree. Accordingly, dispersing techniques for highly dispersing ε-iron oxide to a degree suited to magnetic recording media for high-density recording have not been adequately investigated.

### SUMMARY OF THE INVENTION

The present invention provides for a magnetic recording medium having a magnetic layer in which ε-iron oxide powder has been dispersed to a high degree.

The present inventor conducted extensive research, resulting in the discovery that a compound having at least one substituent selected from the group consisting of a hydroxyl group and a quaternary ammonium salt group was useful as a dispersing agent capable of dispersing ε-iron oxide powder to a high degree. The present invention was devised on that basis.

An aspect of the present invention relates to a magnetic recording medium comprising a magnetic layer comprising a ferromagnetic powder and a binder on a nonmagnetic support, wherein

the ferromagnetic powder is an ε-iron oxide powder, and

the magnetic layer comprises a compound comprising at least one substituent selected from the group consisting of a hydroxyl group and a quaternary ammonium salt group.

In an embodiment, the above compound is an aromatic compound comprising at least one hydroxyl group.

In an embodiment, the above compound is an aromatic compound comprising at least one hydroxyl group directly substituted onto an aromatic ring.

In an embodiment, the number of aromatic rings comprised in the aromatic compound is one.

In an embodiment, the aromatic ring comprised in the aromatic compound is a naphthalene ring.

In an embodiment, the number of aromatic rings comprised in the aromatic compound is one, and the aromatic ring is a naphthalene ring.

In an embodiment, the above compound is dihydroxynaphthalene.

In an embodiment, the magnetic layer comprises inorganic oxide colloidal particles and no carbon black.

In an embodiment, the inorganic oxide colloidal particles are silica colloidal particles.

In an embodiment, the above compound is an aliphatic compound comprising at least one quaternary ammonium salt group.

In an embodiment, the aliphatic group contained in the aliphatic compound is an alkyl group.

In an embodiment, the above compound is cetyltrimethylammonium bromide.

As set forth above, ε-iron oxide powder is a magnetic powder that is suited for high-density recording because it can have high thermal stability. An aspect of the present invention can provide a magnetic recording medium for high-density recording that comprises a magnetic layer in which ε-iron oxide powder is dispersed to a high degree.

Other exemplary embodiments and advantages of the present invention may be ascertained by reviewing the present disclosure.

### DETAILED DESCRIPTION OF THE EMBODIMENTS

Unless otherwise stated, a reference to a compound or component includes the compound or component by itself, as well as in combination with other compounds or components, such as mixtures of compounds.

As used herein, the singular forms “a,” “an,” and “the” include the plural reference unless the context clearly dictates otherwise.

Except where otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not to be considered as an attempt to limit the application of the doctrine of equivalents to the scope of the claims, each numerical parameter should be construed in light of the number of significant digits and ordinary rounding conventions.

Additionally, the recitation of numerical ranges within this specification is considered to be a disclosure of all numerical values and ranges within that range. For example, if a range is from about 1 to about 50, it is deemed to include, for example, 1, 7, 34, 46.1, 23.7, or any other value or range within the range.

The following preferred specific embodiments are, therefore, to be construed as merely illustrative, and non-limiting to the remainder of the disclosure in any way whatsoever. In this regard, no attempt is made to show structural details of the present invention in more detail than is necessary for fundamental understanding of the present invention; the description making apparent to those skilled in the art how several forms of the present invention may be embodied in practice.

An aspect of the present invention relates to a magnetic recording medium comprising a magnetic layer comprising a ferromagnetic powder and a binder on a nonmagnetic support. In the above magnetic recording medium, the ferromagnetic powder is an ε-iron oxide powder, and the magnetic layer comprises a compound comprising at least one substituent selected from the group consisting of a hydroxyl group and a quaternary ammonium salt group. According to an aspect of the present invention, a magnetic recording medium having a magnetic layer in which the ε-iron oxide powder is dispersed to a high degree by employing the above compound as a magnetic layer component.

The magnetic recording medium according to an aspect of the present invention will be described in greater detail below.

Magnetic Layer

The magnetic layer comprises an ε-iron oxide powder, a binder, and a compound comprising at least one substituent selected from the group consisting of a hydroxyl group and a quaternary ammonium salt group, and can contain any of various additives.

It is desirable to employ a microparticulate magnetic material that is suitable as the magnetic material in a magnetic recording medium for high-density recording and that has a particle size ranging from 8 to 30 nm as the ε-iron oxide powder. The particle size preferably ranges from 8 to 20 nm. In the present invention, the particle size is a value measured by the following method.

The particles are photographed at 100,000-fold magnification with a model H-9000 transmission electron microscope made by Hitachi and printed on photographic paper at an overall magnification of 500,000-fold to obtain a particle photograph. The targeted particles are selected in the particle photograph, the contours of the particles are traced with a digitizer, and the particle size is measured with KS-400 Carl Zeiss image analysis software. For the powder comprised of gathering particles, the size of 500 particles is measured and the average value of the particle size is adopted as a particle size (average particle size).

In the present invention, the size of the particles or powder of magnetic particles or the like (referred to as the “particle size”, hereinafter), (1) is given by the length of the major axis of the particle, that is, the major axis length when the particles are acicular, spindle-shaped, cylindrical in shape (with the height being greater than the maximum major diameter of the bottom surface), or the like; (2) is given by the maximum major diameter of the plate surface or bottom surface when the particles are tabular or cylindrical in shape (with the thickness or height being smaller than the maximum major diameter of the plate surface or bottom surface); and (3) is given by the diameter of a circle of equal perimeter when the particles are spherical, polyhedral, or of indeterminate shape, and the major axis of the particle cannot be specified based on the shape. The term “diameter of a circle of equal perimeter” can be obtained by circular projection.

The average particle size of the particles is the arithmetic average of the above particle size and is obtained by measuring 500 primary particles, as set forth above. The term “primary particle” refers to an independent particle that has not aggregated.

The average acicular ratio of the powder refers to the arithmetic average of the value of the (major axis length/minor axis length) of each powder, obtained by measuring the length of the minor axis of the powder in the above measurement, that is, the minor axis length. The term “minor axis length” means the length of the minor axis constituting a powder for a powder size of definition (1) above, and refers to the thickness or height for definition (2) above. For (3) above, the (major axis length/minor axis length) can be deemed for the sake of convenience to be 1, since there is no difference between the major and minor axes.

When the shape of the powder is specified, for example, as in powder size definition (1) above, the average powder size refers to the average major axis length. For definition (2) above, the average powder size refers to the average plate diameter, with the arithmetic average of (maximum major diameter/thickness or height) being referred to as the average plate ratio. For definition (3), the average powder size refers to the average diameter (also called the average particle diameter).

Shape anisotropy becomes larger for (2), (3), and (1) in this order. From the perspective of preparing microparticles, it is desirable to select the embodiment with which shape anisotropy can be simply increased when an axis of easy magnetization is subjected to in-plane orientation. By contrast, when an axis of easy magnetization is subjected to vertical orientation for vertical recording, a desirable order is (2), (1), and then (3) because it is better to take flow orientation into consideration. Additionally, from the perspective of thermal stability, the adoption of (3) is desirable, and the adoption of a spherical shape is preferred.

Known methods of preparing ε-iron oxide include methods employing goethite as a starting material, the reverse micelle method, and the like. These known methods can also be employed in an aspect of the present invention to prepare ε-iron oxide which is then employed as a ferromagnetic powder in the magnetic layer. Commercially available ε-iron oxide can also be employed.

The method of preparing ε-iron oxide by the reverse micelle method will be described as an example below.

The method of preparing ε-iron oxide by the reverse micelle method can comprise:

(1) a step of preparing a precursor of ε-iron oxide in the form of iron salt particles (also referred to hereinafter as “precursor particles”);
(2) a step of coating the precursor particles with a sintering inhibitor, desirably by the sol-gel method;
(3) a step of conducting heating and calcination of the precursor particles that have been coated with the sintering inhibitor; and
(4) a step of removing the sintering inhibitor from the surface of the particles of ε-iron oxide obtained by converting the precursor particles by heating and calcination.

In step (1), the iron salt particles of the precursors can be precipitated from a micelle solution by the reverse micelle method. More specifically, a surfactant and an organic solvent that is immiscible with water are added to an aqueous solution of a water-soluble salt of iron to form a W/O emulsion. To this is then added an alkali to precipitate the iron salt. For example, the particle size of the iron salt that precipitates out can be controlled by means of the mixing ratio of surfactant and water. As set forth farther below, by conducting heating and calcination after coating the precursor particles with the sintering inhibitor, it is possible to prevent the ε-iron oxide particles from sintering and becoming coarse particles. Accordingly, the size of the ε-iron oxide particles finally obtained can be primarily controlled by controlling the size of the iron salt particles that precipitate in step (1).

Examples of the above water-soluble salt are iron nitrate, iron chloride, and the like. Examples of the alkali are sodium hydroxide, potassium hydroxide, sodium carbonate, ammonia water, and the like. The magnetic characteristics of the ε-iron oxide can be controlled by substituting other elements for part of the Fe. Examples of elements that can be substituted are Al, Ga, In, Co, Ni, Mn, Zn, and Ti. Such substituted ε-iron oxide can also be employed as a ferromagnetic powder in the magnet layer in an aspect of the present invention. When obtaining substituted ε-iron oxide by the reverse micelle method, it suffices to add the compound of the substitution element (nitrate, hydroxide, or the like) to the micelle solution in step (1).

Step (2) is a step in which the surface of the precursor particles is coated with a sintering inhibitor prior to heating and calcination so as to prevent the particles from sintering together and forming coarse particles in step (3). From the perspective of uniformly coating the sintering inhibitor on the surface of the precursor particles, the sintering inhibitor is desirably coated on the surface of the precursor particles by the sol-gel method.

Si compounds, Y compounds, and the like can be employed as the sintering inhibitor. From the perspective of enhancing the sintering inhibiting effect and facilitating removal following heating and calcination, the precursor particles are desirably coated with a Si oxide. For example, when a silane compound such as an alkoxy silane is added to the solution in which the precursor particles have precipitated in step (1), silica (SiO₂), which is a hydrolysis product of silane compounds, can be coated on the surface of the precursor particles. The use of tetraethyl orthosilicate (TEOS), which can form silica by the sol-gel method, is preferable as the silane compound.

The precursor particles that have been coated with the sintering inhibitor can be washed to remove unreacted material (the above silane compound and the like) from the surface of the precursor particles prior to step (3). Water, an organic solvent, or some mixture thereof can be employed for washing.

The precursor particles that have been coated with a sintering inhibitor in this manner can be subjected to processing such as being removed from the solution, washed, dried, and pulverized as needed, and then subjected to heating and calcination in step (3). Pulverizing can permit uniform calcination and facilitate removal of the sintering inhibitor following calcination.

The heating and calcination in step (3) can be conducted at an atmospheric temperature ranging from 500° C. to 1,500° C., for example. By way of example, heating and calcination of the precursor particles at the above atmospheric temperature in air makes it possible to convert the precursor particles to ε-iron oxide by an oxidation reaction or the like.

Since the sintering inhibitor may remain on the surface of the particles following calcination, step (4) is normally conducted to remove the sintering inhibitor. The method of removal can be suitably selected based on the type of sintering inhibitor. For example, the above silica can be dissolved away by the method of immersing the particles in an alkali solution such as sodium hydroxide (washing with an alkali), or with hydrofluoric acid (HF) or the like. Because hydrofluoric acid may be difficult to handle, alkali washing is desirably employed. Water washing is then normally conducted. Water washing can be conducted with water or with a water-based solvent such as a mixed solvent of water and, a water-soluble organic solvent such as methanol, ethanol, acetone, N,N-dimethylformamide, N,N-dimethylacetamide, or tetrahydrofuran. In an embodiment, by adding the dispersing agent to the aqueous solution during or after the above water washing, it is possible to coat the particle surface of the ε-iron oxide powder with the dispersing agent.

Following the water washing, the ε-iron oxide can be removed by the known solid-liquid separation method from the aqueous solution. The ε-iron oxide powder that is removed can be optionally subjected to a drying treatment.

Alternatively, following water washing, a solvent replacement treatment can be conducted to replace the solvent with an organic solvent. The solvent replacement treatment can be conducted by a known solvent replacement method of repeatedly adding an organic solvent and conducting solid-liquid separation.

Reference can be made to Examples farther below with regard to preparation of ε-iron oxide particles by the reverse micelle method set forth above.

The binder is contained along with the ε-iron oxide powder and the compound comprising the above substituent in the magnetic layer. A known binder that is employed in the magnetic layer of particulate magnetic recording media can be employed as the binder in the magnetic layer. Examples of the binder are: polyurethane resins; polyester resins; polyamide resins; vinyl chloride resins; styrene; acrylonitrile; methyl methacrylate and other copolymerized acrylic resins; nitrocellulose and other cellulose resins; epoxy resins; phenoxy resins; and polyvinyl acetal, polyvinyl butyral, and other polyvinyl alkyral resins. These may be employed singly or in combinations of two or more. Of these, the desirable binders are the polyurethane resins, acrylic resins, cellulose resins, and vinyl chloride resins. These resins may also be employed as binders in the nonmagnetic layer described further below. Reference can be made to paragraphs [0029] to [0031] in Japanese Unexamined Patent Publication (KOKAI) No. 2010-24113, which is expressly incorporated herein by reference in its entirety, for details of the binder. A polyisocyanate curing agent may also be employed with the above resins.

The magnetic recording medium according to an aspect of the present invention contains one or more compounds comprising at least one substituent selected from the group consisting of a hydroxyl group and a quaternary ammonium salt group in addition to the ε-iron oxide powder and the binder. The incorporation of the above compound can permit dispersion of the ε-iron oxide powder to a high degree, thereby making it possible to obtain a magnetic layer having good surface smoothness.

The above compound will be described in greater detail below.

The above compound is employed singly or in combinations of two or more as a component of the magnetic layer. From the perspective of enhancing dispersion of the ε-iron oxide powder in the magnetic recording medium according to an aspect of the present invention, the above compound is desirably contained in the magnetic layer in a quantity of equal to or more than 1.5 weight parts per 100 weight parts of ferromagnetic powder. From the perspective of increasing the recording density, it is desirable to increase the fill rate of the ferromagnetic powder. Thus, the quantity of additives that are added is desirably reduced within the scope at which they can produce their effects. From this perspective, the content of the above compound in the magnetic layer is desirably equal to or less than 10 weight parts per 100 weight parts of ferromagnetic powder. From the perspective of achieving both a high fill rate and dispersion of the ferromagnetic powder, the content of the above compound in the magnetic layer preferably ranges from 3 to 10 weight parts per 100 weight parts of ferromagnetic powder.

The number of substituents selected from the group consisting of a hydroxyl group and a quaternary ammonium salt group that are contained in the above compound need only be one or more, and can be two, three, or more. One or two groups are desirable to develop a suitable adsorption force.

The above compound can be an aliphatic compound or an aromatic compound. The compound is desirably not a compound such as a polymer compound employed as a binder. That is because the more the additive components employed in the magnetic layer increase, the lower the magnetic powder fill rate becomes, which is undesirable from the perspective of increasing the recording density. However, with polymer compounds, it is necessary to add large amounts to enhance dispersion. To achieve an enhanced dispersion effect with the addition of a small quantity, when the above compound is an aromatic compound, it is desirable for one aromatic ring to be contained within the molecule. In this context, a ring assembly in which two or more rings are joined by single bonds can be counted as a single aromatic ring. When two or more rings are joined by connecting groups other than single bonds, the aromatic rings that are contained are counted as multiple rings. For similar reasons, the compound desirably has a molecular weight of equal to or less than 1,000, preferably equal to or less than 500. The lower limit of the molecular weight of the compound is not specifically limited. By way of example, the lower limit can be equal to or more than 100, or equal to or more than 150.

From the perspective of further enhancing dispersion of the ε-iron oxide powder, the compound comprising one or more hydroxyl groups is desirably an aromatic compound comprising one or more hydroxyl groups. The aromatic ring contained in the aromatic compound comprising one or more hydroxyl groups can be of a single ring structure or a multiple ring structure, and can be a carbon ring or a hetero ring. The multiple ring structure can be in the form of a condensed ring or in the form of a ring assembly in which two or more rings are joined together by single bonds. Specific examples of the above aromatic ring are naphthalene rings, biphenyl rings, anthracene rings, pyrene rings, and phenanthrene rings. Examples of desirable aromatic rings are naphthalene rings, biphenyl rings, anthracene rings, and pyrene rings. Examples of preferred aromatic rings are naphthalene rings and biphenyl rings.

In the above aromatic compound comprising one or more hydroxyl groups, the hydroxyl group can be directly substituted onto the aromatic ring, or can be substituted through a connecting group such as a methylene group, ethylene group, or some other alkylene group. From the perspective of further enhancing dispersion of the ε-iron oxide powder, the hydroxyl group is desirably directly substituted onto the aromatic ring.

The above aromatic ring can comprise one or more substituents in addition to the hydroxyl group. These substituents are not specifically limited. Examples are halogen atoms (such as fluorine atoms, chlorine atoms, bromine atoms, and iodine atoms) and alkyl groups. However, it is undesirable for the adsorption power of the compound added as a dispersing agent to the magnetic particles to be too great because it will sometime promote association of the magnetic particles. From this perspective, the presence of substituents exhibiting adsorption to the surface of the magnetic particles that is greater than that of hydroxyl groups (such as sulfonic acid groups and their salts) is undesirable. Nor is it desirable for the presence of substituents to greatly affect the hydrophilic/hydrophobic property of the compound. From these perspectives, the aromatic compound desirably does not comprise a substituent in addition to the hydroxyl group.

Naphthalene substituted with one or more hydroxyl groups is desirable and dihydroxynaphthalene is preferable as the compound comprising one or more hydroxyl groups set forth above.

The compound comprising one or more quaternary ammonium salt groups refers to the compound denoted by the formula given below. The R in the quaternary ammonium cation denoted by —N⁺R₃ is, for example, an alkyl group having 1 to 5 carbon atoms, desirably a linear alkyl group having 1 to 3 carbon atoms. The three instances of R that are present can each be different, two can be identical, or they can all be identical.

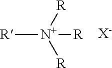

The anion X⁻ forming a salt with the ammonium cation is not specifically limited. From the perspective of availability and the like, halogen anions such as Cl⁻ and Br⁻ are suitable.

From the perspective of further enhancing dispersion of the ε-iron oxide powder, the compound comprising one or more quaternary ammonium salt groups is desirably an aliphatic compound in which R′ in the above formula denotes an aliphatic group. A linear or branched alkyl group is desirable as the aliphatic group denoted by R′. The aliphatic group desirably has about 10 to 20 carbon atoms. The aliphatic group can also optionally comprise one or more substituents such as halogen atoms. When the aliphatic group denoted by R′ comprises one or more substituents, the number of carbon atoms of the aliphatic group refers to the number of carbon atoms of the portion excluding the substituent.

From the perspectives of availability and enhancing dispersion of the ε-iron oxide powder, cetyltrimethylammonium bromide (CTAB) is preferred as the aliphatic compound comprising one or more quaternary ammonium salt groups.

The compound comprising one or more substituents selected from the group consisting of a hydroxyl group and a quaternary ammonium salt group set forth above is available in the form of commercial products and can be readily synthesized by known methods.

Additives can be further added to the magnetic layer as needed. Examples of additives are abrasives, lubricants, dispersing agents, dispersion adjuvants, antifungal agents, antistatic agents, oxidation inhibitors, and carbon black. Commercial products can be suitably selected based on the desired properties for use as additives.

An example of a characteristic that is desirable in a magnetic recording medium, in addition to having a magnetic layer of high surface smoothness, is good running durability. To that end, a component for lowering the coefficient of friction of the magnetic layer (a coefficient of friction-lowering component) is desirably contained in the magnetic layer. In the present invention, the term “coefficient of friction-lowering component” refers to a component that forms suitable protrusions on the surface of the magnetic layer and thus exhibits an effect of lowering the coefficient of friction that is generated by contact with the head during recording or reproduction of a magnetic signal by the magnetic recording medium relative to what it would be had the component not been incorporated. Examples of the coefficient of friction-lowering component are nonmagnetic inorganic particles and carbon black. In the present invention, carbon black is not included among nonmagnetic inorganic particles that function as coefficient of friction-lowering components in the magnetic layer.

Examples of inorganic substances constituting the above nonmagnetic inorganic particles are metal oxides, metal carbonates, metal sulfates, metal nitrides, metal carbides, and metal sulfides. Specific examples are α-alumina with an α-conversion rate of equal to or greater than 90 percent, β-alumina, γ-alumina, θ-alumina, silicon dioxide, silicon carbide, chromium oxide, cerium oxide, α-iron oxide, goethite, corundum, silicon nitride, titanium carbide, titanium dioxide, tin oxide, magnesium oxide, tungsten oxide, zirconium oxide, boron nitride, zinc oxide, calcium carbonate, calcium sulfate, barium sulfate, and molybdenum disulfide. These can be used singly or in combinations of two or more. From the perspectives of the availability of particles of good particle size distribution and dispersion properties, inorganic oxides are desirable and silica (silicon dioxide) is preferred.

From the perspective of dispersion, the use of colloidal particles is desirable as the above nonmagnetic inorganic particles. From the perspective of availability, inorganic oxide colloidal particles are preferred as the colloidal particles. Examples of inorganic oxide colloidal particles are the colloidal particles of the inorganic oxide set forth above. Specific examples are compound inorganic oxide colloidal particles of SiO₂.Al₂O₃, SiO₂.B₂O₃, TiO₂.CeO₂, SnO₂.Sb₂O₃, SiO₂.Al₂O₃.TiO₂, and TiO₂.CeO₂.SiO₂. Desirable examples are inorganic oxide colloidal particles of SiO₂, Al₂O₃, TiO₂, ZrO₂, Fe₂O₃, and the like. From the perspective of the ready availability of monodispersed colloidal particles, silica colloidal particles (colloidal silica) is preferred. By way of example, reference can be made to paragraph [0066] in Japanese Unexamined Patent Publication (KOKAI) No. 2012-164410, which is expressly incorporated herein by reference in its entirety, for details regarding colloidal particles.

From the perspective of forming suitable protrusions for contributing to lowering the coefficient of friction on the surface of the magnetic layer, the average particle size of the above nonmagnetic inorganic particles is desirably equal to or greater than the thickness of the magnetic layer, preferably equal to or greater than 1.2-fold. From the perspective of preventing spacing loss due to excessive protrusion of the nonmagnetic inorganic particles, the average particle size is desirably equal to or less than two-fold the thickness of the magnetic layer, preferably equal to or less than 1.7-fold. To achieve even better electromagnetic characteristics, the average particle size of the nonmagnetic inorganic particles desirably falls within a range of 50 nm to 200 nm. The thickness of the magnetic layer is desirably optimized based on the saturation magnetization of the magnetic head employed, the head gap length, and the bandwidth of the recording signal. From the perspective of enhancing the electromagnetic characteristics, the thickness of the magnetic layer is desirably equal to or less than 200 nm, preferably equal to or less than 170 nm, and more preferably, equal to or less than 80 nm. From the perspective of forming a uniform magnetic layer, it is desirably equal to or more than 10 nm, preferably equal to or more than 30 nm, and more preferably, equal to or more than 50 nm. The average particle size of the above nonmagnetic inorganic particles is defined as the value measured by the method described in paragraph [0068] Japanese Unexamined Patent Publication (KOKAI) No. 2012-164410.

The content of the above nonmagnetic inorganic particles in the magnetic layer is desirably set to within a range making it possible to achieve both good electromagnetic characteristics and lowering of the coefficient of friction. Specifically, 0.5 to 20 weight parts per 100 weight parts of the ε-iron oxide powder is desirable, 1 to 5 weight parts is preferred, and 1 to 3 weight parts is of greater preference.

Carbon black, which is widely employed as a magnetic layer component in particulate magnetic recording media, is desirably not combined for use in the magnetic layer comprising an aromatic compound in which one or more hydroxyl groups are directly substituted onto the aromatic ring as the compound comprising one or more substituents selected from the group consisting of a hydroxyl group and a quaternary ammonium salt group. That is because an aromatic compound in which one or more hydroxyl groups are directly substituted onto the aromatic ring tends to bind to carbon black, which is thought to end up forming coarse aggregates when the carbon black and the ε-iron oxide particles associate through the aromatic compound.

Thus, the magnetic layer containing an aromatic compound in which one or more hydroxyl groups are directly substituted onto the aromatic ring desirably comprises a coefficient of friction-lowering compound in the form of nonmagnetic inorganic particles, desirably inorganic oxide colloidal particles, and preferably, colloidal silica particles; and desirably does not comprise carbon black. In this context, the phrase “does not comprise carbon black” or “comprises no carbon black” means that none has been actively added as a magnetic layer component. For example, the unintentional mixing in of carbon black contained as a component in some other layer (such as the nonmagnetic layer) into the magnetic layer in the process of manufacturing a magnetic recording medium, for example, is permissible.

Nonmagnetic Layer

In an aspect of the present invention, a nonmagnetic layer comprising a nonmagnetic powder and a binder can be formed between the nonmagnetic support and the magnetic layer. Both organic and inorganic substances may be employed as the nonmagnetic powder in the nonmagnetic layer. Carbon black may also be employed. Examples of inorganic substances are metals, metal oxides, metal carbonates, metal sulfates, metal nitrides, metal carbides, and metal sulfides. These nonmagnetic powders are commercially available and can be manufactured by the known methods. Reference can be made to paragraphs [0036] to [0039] in Japanese Unexamined Patent Publication (KOKAI) No. 2010-24113 for details thereof.

Binders, lubricants, dispersing agents, additives, solvents, dispersion methods, and the like suited to the magnetic layer may be adopted to the nonmagnetic layer. In particular, known techniques for the quantity and type of binder, the quantity and type of additives and dispersing agents employed in the magnetic layer may be adopted thereto. Carbon black and organic powders can be added to the nonmagnetic layer. Reference can be made to paragraphs [0040] to [0042] in Japanese Unexamined Patent Publication (KOKAI) No. 2010-24113 for details thereof.

Nonmagnetic Support

A known film such as biaxially-oriented polyethylene terephthalate, polyethylene naphthalate, polyamide, polyamidoimide, or aromatic polyamide can be employed as the nonmagnetic support. Of these, polyethylene terephthalate, polyethylene naphthalate, and polyamide are preferred.

These supports can be corona discharge treated, plasma treated, treated to facilitate adhesion, heat treated, or the like in advance. The center average roughness, Ra, at a cutoff value of 0.25 mm of the nonmagnetic support suitable for use in an aspect of the present invention desirably ranges from 3 to 10 nm.

Layer Structure

As for the thickness structure of the magnetic recording medium according to an aspect of the present invention, the thickness of the nonmagnetic support desirably ranges from 3 to 80 μm. The thickness of the magnetic layer is as set forth above. At least one magnetic layer is sufficient. The magnetic layer may be divided into two or more layers having different magnetic characteristics, and a known configuration relating to multilayered magnetic layer may be applied.

The nonmagnetic layer is, for example, 0.1 to 3.0 μm, desirably 0.3 to 2.0 μm, and preferably, 0.5 to 1.5 μm in thickness. The nonmagnetic layer of the magnetic recording medium of an aspect of the present invention can exhibit its effect so long as it is substantially nonmagnetic. It can exhibit the effect of the present invention, and can be deemed to have essentially the same structure as the magnetic recording medium in the present invention, for example, even when impurities are contained or a small quantity of magnetic material is intentionally incorporated. The term “essentially the same” means that the residual magnetic flux density of the nonmagnetic layer is equal to or lower than 10 mT, or the coercive force is equal to or lower than 7.96 kA/m (equal to or lower than 100 Oe), with desirably no residual magnetic flux density or coercive force being present.

Backcoat Layer

A backcoat layer can be provided on the surface of the nonmagnetic support opposite to the surface on which the magnetic layer is provided, in an aspect of the present invention. The backcoat layer desirably comprises carbon black and inorganic powder. The formula of the magnetic layer or nonmagnetic layer can be applied to the binder and various additives for the formation of the backcoat layer. The backcoat layer is preferably equal to or less than 0.9 μm, more preferably 0.1 to 0.7 μm, in thickness.

Manufacturing Steps

The coating liquid for forming each layer, such as the magnetic layer, the nonmagnetic layer, the backcoat layer and the like, of the magnetic recording medium according to an aspect of the present invention normally comprises at least a kneading step, a dispersing step, and a mixing step to be carried out, if necessary, before and/or after the kneading and dispersing steps. Each of the individual steps may be divided into two or more stages. All of the starting materials employed in an aspect of the present invention, including the ε-iron oxide powder, the nonmagnetic powder, the compound comprising at least one substituent selected from the group consisting of a hydroxyl group and a quaternary ammonium salt group (dispersing agent), binders, the coefficient of friction-lowering component, carbon black, abrasives, antistatic agents, lubricants, solvents, and the like, may be added at the beginning of, or during, any of the steps. Moreover, the individual starting materials may be divided up and added during two or more steps. For example, polyurethane may be divided up and added in the kneading step, the dispersion step, and the mixing step for viscosity adjustment after dispersion. To achieve the object of the present invention, conventionally known manufacturing techniques may be utilized for some of the steps. A kneader having a strong kneading force, such as an open kneader, continuous kneader, pressure kneader, or extruder is preferably employed in the kneading step. Details of the kneading process are described in Japanese Unexamined Patent Publication (KOKAI) Heisei Nos. 1-106338 and 1-79274. The contents of these applications are incorporated herein by reference in their entirety. Further, glass beads and other beads may be employed to disperse the coating liquid for each layer. Dispersing media with a high specific gravity such as zirconia beads, titania beads, and steel beads are suitable for use. The particle diameter and filling rate of these dispersing media can be optimized for use. A known dispersing device may be employed. Reference can be made to paragraphs [0051] to [0057] in Japanese Unexamined Patent Publication (KOKAI) No. 2010-24113 for details of the method of manufacturing a magnetic recording medium. As set forth above, in the process of manufacturing the ε-iron oxide powder, the dispersing agent can also be used by adding it to the aqueous solution during or after water washing to coat the ε-iron oxide powder.

The magnetic recording medium according to an aspect of the present invention as set forth above can have a magnetic layer containing the ε-iron oxide powder having high thermal stability with high surface smoothness. Thus, it is suitable as a magnetic recording medium for high-density recording. An aspect of the present invention can provide a magnetic recording medium having a magnetic layer comprising ε-iron oxide and exhibiting surface smoothness ranging from 1.0 to 2.5 nm, or 1.0 to 2.0 nm, as the centerline average roughness (Ra) measured by an atomic force microscope (AFM).

### EXAMPLES

The present invention will be described in detail below based on specific examples and comparative examples. However, the present invention is not limited to the examples. The terms “part(s)” and “percent” given below are “weight part(s)” and “weight percent”. The room temperatures stated below are 25° C.±1° C., and unless specifically stated otherwise, all operations were conducted at room temperature.

### Preparation Example 1

### Synthesis of Unsubstituted ε-Iron Oxide

### [Procedure 1: Preparation of Micelle Solution]

Two micelle solutions in the form of micelle solution I and micelle solution II were prepared by the following method.

### (1) Preparation of Micelle Solution I

To 10.46 g of iron (III) nitrate nonahydrate and 123.7 g of cetyltrimethylammonium bromide were added 207.9 g of pure water, 439.8 g of n-octane and 101.2 g of 1-butanol were then added, and the mixture was stirred and dissolved.

### (2) Preparation of Micelle Solution II

To 123.7 g of cetyltrimethylammonium bromide were added 178.5 g of 10 percent ammonia water, 439.8 g of n-octane, and 101.2 g of 1-butanol and the mixture was stirred and dissolved.

### [Procedure 2: Precipitation of Precursor Particles]

Micelle solution II was added dropwise with stirring to micelle solution I. Following the dropwise addition, the mixture was continuously stirred for 30 minutes.

[Procedure 3: Coating of Precursor Particles with Sintering Inhibitor]

Precursor particles in the form of iron hydroxide Fe(OH)₂ precipitated in the mixture obtained in Procedure 2. While stirring the mixture, 48.9 g of tetraethoxysilane (TEOS) was added to it. Stirring was continued for about a day. This caused the TEOS to hydrolyze and caused silica to coat the surface of the precursor particles in the mixture.

### [Procedure 4: Washing]

The solution obtained by Procedure 3 was charged to a separating funnel, 200 mL of a 1:1 mixed solution of pure water and ethanol was added, and the mixture was left standing until a reddish-brown portion separated from the remainder. Everything but the reddish-brown portion was discarded. This operation was repeated three times, the mixture was placed in a centrifuge, and centrifugation was conducted. The precipitate obtained by this process was recovered. The recovered precipitate was redispersed with a mixed solution of chloroform and ethanol, centrifugation was conducted, and the precipitate obtained was recovered.

### [Procedure 5: Heating and Calcination]

The precipitate obtained by Procedure 4 was dried by air drying and pulverized in a mortar. Subsequently, two hours of heat treatment were conducted at an internal furnace temperature of 1,000° C. while feeding air at 1 L/min in an image furnace made by ULVAC-Riko. This yielded ε-iron oxide particles coated with a sintering inhibitor in the form of silica.

### [Procedure 6: Removing the Sintering Inhibitor]

A 1 g quantity of the ε-iron oxide particles coated with silica that were obtained by Procedure 5 was placed in 25 cc of a 5 N sodium hydroxide aqueous solution and processed for four hours while applying ultrasound at a temperature of 70° C. Subsequently, the mixture was stirred for a day and a night. The silica was thus removed from the surface of the ε-iron oxide particles.

Subsequently, washing and centrifugation were repeated, washing was conducted until the supernatant dropped lower than pH 8, and air drying was conducted to obtain ε-iron oxide particles. The fact that the particles obtained were ε-iron oxide was confirmed by powder X-ray diffraction analysis with an X' Pert PRO (radiation source: CuKa, radiation, voltage 45 kV, current 40 mA) made by PANalytical Corp.

### Preparation Example 2

### Synthesis of Al-Substituted ε-Iron Oxide

With the exception that micelle solution I in Procedure 1 was prepared by the following method and an internal furnace temperature of 1,025° C. was employed in Procedure 5, Al-substituted ε-iron oxide powder in which a portion of the Fe was replaced with Al was obtained by the same method as in Preparation Example 1.

### <Preparation of Micelle Solution I>

To 8.37 g of iron (III) nitrate nonahydrate, 1.94 g of aluminum nitrate, and 123.7 g of cetyltrimethylammonium boride were added 207.9 g of pure water. To this were then added 439.8 g of n-octane and 101.2 g of 1-butanol, and the mixture was stirred and dissolved.

### Examples 1 to 4, Comparative Examples 1 and 2

### 1-1. Formula of Magnetic Layer Coating Liquid

ε-Iron oxide powder listed in Table 1: 100 parts
Polyurethane resin (functional group: —SO₃Na, functional group concentration: 180 eq/t): 14 parts
Oleic acid: 1.5 parts
2,3-Dihydroxynaphthalene: See Table 1
Alumina powder (average particle diameter: 120 nm): 50 parts
Silica colloidal particles (colloidal silica, average particle size: 100 nm): 2 parts
Cyclohexanone: 110 parts
Methyl ethyl ketone: 100 parts
Toluene: 100 parts
Butyl stearate: 2 parts
Stearic acid: 1 part

### 1-2. Formula of Nonmagnetic Layer Coating Liquid

Nonmagnetic inorganic powder (ε-iron oxide): 85 parts
   Surface treatment agents: Al₂O₃, SiO₂
   Major axis diameter: 0.05 μm
   Tap density: 0.8
   Acicular ratio: 7
   Specific surface area by BET method: 52 m²/g
   pH: 8
   DBP oil absorption capacity: 33 g/100 g
Carbon black: 20 parts
   DBP oil absorption capacity: 120 ml/100 g
   pH: 8
   Specific surface area by BET method: 250 m²/g
   Volatile content: 1.5 percent
Polyurethane resin (functional group: —SO₃Na, functional group concentration: 180 eq/t): 15 parts
Phenylphosphonic acid: 3 parts
α-Al₂O₃ (average particle diameter: 0.2 μm): 10 parts
Cyclohexanone: 140 parts
Methyl ethyl ketone: 170 parts
Butyl stearate: 2 parts
Stearic acid: 1 part

### 1-3. Preparation of Magnetic Tape

The various components of each of the above coating liquids were knead for 60 minutes in an open kneader and then dispersed for 720 to 1,080 minutes in a sand mill employing zirconia beads (bead diameter 0.5 mm or 0.1 mm). Six parts of trifunctional low-molecular-weight polyisocyanate compound (Coronate 3041 made by Nippon Polyurethane Industry Co., Ltd.) were added to each of the dispersions obtained, stirring was conducted for 20 minutes, and the dispersions were passed through filters having an average pore diameter of 1 μm to prepare a magnetic layer coating liquid and a nonmagnetic layer coating liquid.

The nonmagnetic layer coating liquid was coated in a quantity calculated to yield a thickness of 1.5 μm upon drying on a polyethylene naphthalate base 5 μm in thickness and dried at 100° C. Immediately thereafter, the magnetic layer coating liquid was coated wet-on-dry in a quantity calculated to yield a thickness of 0.08 μm upon drying, and dried at 100° C. While the magnetic layer was still wet, a perpendicular magnetic field orientation was imparted with a magnet of 300 mT (3,000 gauss). A seven-stage calender comprised of only metal rolls was then used to conduct a surface smoothing treatment at a temperature of 90° C. and a linear pressure of 300 kg/cm at a speed of 100 m/min. A heat curing treatment was then conducted for 24 hours at 70° C. and the product was slit to ½ inch width to prepare a magnetic tape.

### 2. Evaluation of the Magnetic Tape

### 2-1. Coercive Force

Evaluation was conducted with a vibrating superconducting magnetometer (VSM) made by Tamagawa Seisakusho under conditions of an applied magnetic field of 3,184 kA/m (40 kOe).

### 2-2. Magnetic Layer Surface Roughness Ra

A surface area of 40 μm×40 μm of the magnetic layer was measured in contact mode with an atomic force microscope (AFM: Nanoscope III made by Digital Instruments) and the centerline average surface roughness (Ra) was measured.

The results are given in Table 1.

TABLE 1

| | | Quantity of 2,3- | | Coercive force | |
|---|---|---|---|---|---|
| | ε-iron | dihydroxynaphthalene | Coefficient of friction- | of tape | |
| | oxide | in the magnetic layer | lowering component | Hc | Ra (nm) |
| Ex. 1 | Preparation Ex. 1 | 6 parts | Silica colloidal particles | 366 kA/m | 1.7 |
| | (unsubstituted) | | | (4600 Oe) | |
| Ex. 2 | Preparation Ex. 2 | 6 parts | Silica colloidal particles | 442 kA/m | 1.8 |
| | (Al-substituted) | | | (5550 Oe) | |
| Ex. 3 | Preparation Ex. 1 | 6 parts | None | 370 kA/m | 1.8 |
| | (unsubstituted) | | | (4650 Oe) | |
| Ex. 4 | Preparation Ex. 2 | 6 parts | None | 450 kA/m | 1.7 |
| | (Al-substituted) | | | (5650 Oe) | |
| Comp. | Preparation Ex. 1 | None | Silica colloidal particles | 363 kA/m | 2.9 |
| Ex. 1 | (unsubstituted) | | | (4560 Oe) | |
| Comp. | Preparation Ex. 2 | None | Silica colloidal particles | 442 kA/m | 3 |
| Ex. 2 | (Al-substituted) | | | (5550 Oe) | |

A comparison of Examples 1 to 4 and Comparative Examples 1 and 2 reveals that the use of the above dispersing agent made it possible to disperse the ε-iron oxide powder to a high degree, thereby making it possible to form a magnetic layer with a low magnetic layer surface Ra and good surface smoothness.

From the results given in Table 1, it will be apparent that incorporating ε-iron oxide powder made it possible to fabricate a magnetic tape exhibiting high coercive force, and that replacing a portion of the Fe in the ε-iron oxide with Al made it possible to adjust the coercive force.

### 2. Evaluation of the Magnetic Tape

### 2-3 Running Durability (Measurement of Coefficient of Friction)

When the coefficient of friction was measured by the following method in Examples 1 to 4 and Comparative Examples 1 and 2 shown in Table 1, the coefficients of friction (μ values) of Examples 1 and 2 and Comparative Examples 1 and 2 were: Example 1: 0.24; Example 2: 0.22; Comparative Example 1: 0.19; Comparative Example 2: 0.20.

In contrast, in Examples 3 and 4, the coefficients of friction were high and the cylindrical SUS rod set forth below ended up adhering to the magnetic layer surface, making back-and-forth sliding difficult.

Based on the above results, it was found desirable to employ a coefficient of friction-lowering component as a magnetic layer component to obtain a magnetic recording medium affording good running durability in addition to a magnetic layer with surface smoothness.

### <Method of Measuring Coefficient of Friction (μ Value)>

The magnetic layer surface of the magnetic tape was repeatedly slid back and forth 100 times at a speed of 10 mm/s with a load of 100 g over a cylindrical SUS rod with a centerline average surface roughness Ra of 5 nm as measured by AFM, at which point the coefficient of friction (μ value) was determined.

### Examples 5 and 6, Comparative Examples 3 and 4

With the exception that two parts of carbon black (average particle size 15 nm) were employed instead of silica colloidal particles (colloidal silica) as the coefficient of friction-lowering component, a magnetic tape was prepared and evaluated in the same manner as in Examples 1 and 2 and Comparative Examples 1 and 2. The results are given in Table 2.

TABLE 2

| | | Compound | | | | |
|---|---|---|---|---|---|---|
| | | comprising at least | | | | |
| | | one substituent | | | | |
| | | selected from the | | | | |
| | | group consisting of | | | | |
| | | a hydroxyl group | | Coercive | | |
| | | quaternary | Coefficient of | force | | |
| | ε-iron | ammonium | friction-lowering | of tape | Ra | μ |
| | oxide | salt group | component | Hc | (nm) | value |
| Ex. 5 | Preparation | 2,3- | Carbon black | 362 kA/m | 2.9 | 0.19 |
| | Ex. 1 | dihydroxynaphthalene | | (4550 Oe) | | |
| | (unsubstituted) | | | | | |
| Ex. 6 | Preparation | 2,3- | Carbon black | 438 kA/m | 2.8 | 0.20 |
| | Ex. 2 | dihydroxynaphthalene | | (5500 Oe) | | |
| | (Al- | | | | | |
| | substituted) | | | | | |
| Comp. | Preparation | None | Carbon black | 362 kA/m | 3.0 | 0.20 |
| Ex. 3 | Ex. 1 | | | (4550 Oe) | | |
| | (unsubstituted) | | | | | |
| Comp. | Preparation | None | Carbon black | 446 kA/m | 2.9 | 0.21 |
| Ex. 4 | Ex. 2 | | | (5600 Oe) | | |
| | (Al- | | | | | |
| | substituted) | | | | | |

The fact that ε-iron oxide powder could not be adequately dispersed in the magnetic layers of Comparative Examples 3 and 4, which did not contain 2,3-dihydroxynaphthalene, was thought to be why the magnetic layer surface Ra was higher than in Examples shown in Table 1.

Additionally, the reason why the magnetic layer surface Ra in Examples 5 and 6 was higher than in Examples shown in Table 1 was thought to be that the carbon black, employed as the coefficient of friction-lowering component, associated with the ε-iron oxide particles through the 2,3-dihydroxynaphthalene.

On the other hand, as set forth above, Examples 3 and 4, which did not contain a coefficient of friction-lowering component, exhibited poor running durability.

Based on the above results, it was determined that when an aromatic compound in which one or more hydroxyl groups were directly substituted onto the aromatic ring was used to enhance the dispersion of ε-iron oxide powder, it is desirable that carbon black was not employed as a magnetic layer component as well as a coefficient of friction-lowering component other than carbon black, such as silica colloidal particles, was employed to obtain a magnetic recording medium with good running durability in addition to a magnetic layer with surface smoothness.

### Example 7

With the exceptions that 100 parts (based on solid component conversion of the wet cake prepared in Preparation Example 3) of the CTAB-coated, Al-substituted ε-iron oxide powder prepared in Preparation Example 3 below was employed as the ferromagnetic powder in the magnetic layer and 2,3-dihydroxynaphthalene was not added as a magnetic layer component, a magnetic tape was prepared and evaluated by the same methods as in Examples 1 and 2. The evaluation results are given in Table 3.

### Preparation Example 3

### Synthesis of CTAB-Coated, Al-Substituted ε-Iron Oxide

With the exception that Procedure 6 was changed in the following manner, the same operations were carried out as in Preparation Example 2 to fabricate Al-coated ε-iron oxide the particle surfaces of which were coated with cetyltrimethylammonium bromide (CTAB).

[Procedure 6: Removal of Sintering Inhibitor and Coating with CTAB]

A 1 g quantity of the ε-iron oxide particles coated with silica that had been obtained by Procedure 5 were placed in 25 cc of a 5 N sodium hydroxide aqueous solution and processed for four hours while applying ultrasound at a temperature of 70° C. Subsequently, the mixture was stirred for a day and a night. The silica was then removed from the surface of the ε-iron oxide particles.

Subsequently, water washing and centrifugation were repeatedly conducted and washing was conducted until the supernatant dropped lower than pH 8. To the aqueous solution following washing was added 20 cc of a 1 weight percent aqueous solution of CTAB (resembling a suspension) per 1 g of particles contained in the aqueous solution. Following exposure to ultrasound, centrifugation was conducted and the supernatant was discarded. Subsequently, 20 cc of methyl ethyl ketone (MEK) was added, irradiation with ultrasound was conducted, and centrifugation was conducted. This cycle was repeated twice, yielding a CTAB-coated, Al-substituted ε-iron oxide wet cake (the wet cake was used to prepare a magnetic layer coating liquid without being dried).

TABLE 3

| | | | Coefficient | Coercive | | |
|---|---|---|---|---|---|---|
| | | | of friction- | force | | |
| | | Dispersing | lowering | of tape | Ra | μ |
| | ε-iron oxide | agent | component | Hc | (nm) | value |
| Ex. 7 | Preparation Ex. 3 | CTAB | Silica | 438 kA/m | 2.0 | 0.23 |
| | (CTAB-coated, | | colloidal | (5500 Oe) | | |
| | Al-substituted) | | particles | | | |

Based on a comparison of Example 7 and Comparative Examples 1 and 2 in Table 1, the use of CTAB, an aliphatic compound comprising a quaternary ammonium salt group, was determined to have permitted the formation of a magnetic layer having a low magnetic layer surface Ra and good surface smoothness because the ε-iron oxide powder could be highly dispersed.

When a magnetic tape was prepared and evaluated in the same manner as in Example 7 with the exception that two parts of carbon black (average particle size 15 nm) were employed instead of colloidal silica as a coefficient of friction-lowering component, no increase in the magnetic layer surface Ra such as that seen in the comparison of Examples 5 and 6 and Examples 1 and 2 was found.

The present invention is useful in the field of manufacturing magnetic recording media for high-density recording.

Although the present invention has been described in considerable detail with regard to certain versions thereof, other versions are possible, and alterations, permutations and equivalents of the version shown will become apparent to those skilled in the art upon a reading of the specification and study of the drawings. Also, the various features of the versions herein can be combined in various ways to provide additional versions of the present invention. Furthermore, certain terminology has been used for the purposes of descriptive clarity, and not to limit the present invention. Therefore, any appended claims should not be limited to the description of the preferred versions contained herein and should include all such alterations, permutations, and equivalents as fall within the true spirit and scope of the present invention.

Having now fully described this invention, it will be understood to those of ordinary skill in the art that the methods of the present invention can be carried out with a wide and equivalent range of conditions, formulations, and other parameters without departing from the scope of the invention or any embodiments thereof.

All patents and publications cited herein are hereby fully incorporated by reference in their entirety. The citation of any publication is for its disclosure prior to the filing date and should not be construed as an admission that such publication is prior art or that the present invention is not entitled to antedate such publication by virtue of prior invention.

What is claimed is:

1. A magnetic recording medium comprising a magnetic layer comprising a ferromagnetic powder and a binder on a nonmagnetic support, wherein
the ferromagnetic powder is an ε-iron oxide powder, and
the magnetic layer comprises a compound comprising at least one substituent selected from the group consisting of a hydroxyl group and a quaternary ammonium salt group.

2. The magnetic recording medium according to claim 1, wherein the compound is an aromatic compound comprising at least one hydroxyl group.

3. The magnetic recording medium according to claim 1, wherein the compound is an aromatic compound comprising at least one hydroxyl group directly substituted onto an aromatic ring.

4. The magnetic recording medium according to claim 1, wherein the number of aromatic rings comprised in the aromatic compound is one.

5. The magnetic recording medium according to claim 1, wherein the aromatic ring comprised in the aromatic compound is a naphthalene ring.

6. The magnetic recording medium according to claim 1, wherein the number of aromatic rings comprised in the aromatic compound is one, and the aromatic ring is a naphthalene ring.

7. The magnetic recording medium according to claim 1, wherein the compound is dihydroxynaphthalene.

8. The magnetic recording medium according to claim 3, wherein the magnetic layer comprises inorganic oxide colloidal particles and no carbon black.

9. The magnetic recording medium according to claim 8, wherein the inorganic oxide colloidal particles are silica colloidal particles.

10. The magnetic recording medium according to claim 4, wherein the magnetic layer comprises inorganic oxide colloidal particles and no carbon black.

11. The magnetic recording medium according to claim 10, wherein the inorganic oxide colloidal particles are silica colloidal particles.

12. The magnetic recording medium according to claim 5, wherein the magnetic layer comprises inorganic oxide colloidal particles and no carbon black.

13. The magnetic recording medium according to claim 12, wherein the inorganic oxide colloidal particles are silica colloidal particles.

14. The magnetic recording medium according to claim 6, wherein the magnetic layer comprises inorganic oxide colloidal particles and no carbon black.

15. The magnetic recording medium according to claim 14, wherein the inorganic oxide colloidal particles are silica colloidal particles.

16. The magnetic recording medium according to claim 7, wherein the magnetic layer comprises inorganic oxide colloidal particles and no carbon black.

17. The magnetic recording medium according to claim 16, wherein the inorganic oxide colloidal particles are silica colloidal particles.

18. The magnetic recording medium according to claim 1, wherein the compound is an aliphatic compound comprising at least one quaternary ammonium salt group.

19. The magnetic recording medium according to claim 18, wherein an aliphatic group contained in the aliphatic compound is an alkyl group.

20. The magnetic recording medium according to claim 1, wherein the compound is cetyltrimethylammonium bromide.
